(19) United States
(12) Patent Application Publication
(10) Pub. No.: US 2015/0035408 A1
(43) Pub. Date: Feb. 5, 2015

(54) ELECTROSTATIC DEVICE AND METHOD FOR RECOVERING MECHANICAL ENERGY BY TRIBOELECTRIC EFFECT

(71) Applicant: COMMISSARIAT A L'ENERGIE ATOMIQUE ET AUX ENE ALT, Paris (FR)

(72) Inventors: Ghislain Despesse, Saint-Egreve (FR); Sebastien Boisseau, Grenoble (FR); Dominique Vicard, Bernin (FR)

(21) Appl. No.: 14/382,932

(22) PCT Filed: Mar. 5, 2013
(86) PCT No.: PCT/EP2013/054405

§ 371 Date: Sep. 4, 2014

(30) Foreign Application Priority Data
Mar. 5, 2012 (FR) 1251996

(51) Int. Cl. H02N 1/04; H02N 1/08

(52) U.S. Cl. CPC H02N 1/04; H02N 1/08
USPC 310/310; 2/69; 2/227

(57) ABSTRACT

A device for recovering energy including a first assembly and a second assembly facing each other, the first assembly including a first conductive element and a first dielectric element carried by the first conductive element, and the second assembly including a second conductive element. The first dielectric element is arranged between the first conductive element and the second conductive element. The device further includes a mechanism ensuring that the first dielectric element comes into contact with the second conductive element. A material of the first dielectric element and the material of the second conductive element have different triboelectric affinities.

### TECHNICAL FIELD AND PRIOR ART

The present invention relates to an electrostatic device for recovering mechanical energy as electrical energy using the electrostatic charges accumulated by the triboelectric effect on at least one dielectric material.

In the field of energy recovery the use of variable capacitance systems is known, said systems comprising at least one fixed electrode and at least one moving electrode facing the fixed electrode, the electrodes being separated by an air or vacuum gap. The moving electrode is made to move by external vibration, and by introducing and removing a charge into the system at precise points in time it is possible to convert the vibrational energy into electrical energy.

These systems also require polarisation of the structure at each cycle in order to carry out energy recovery cycles. This polarisation requires electronic means for transferring electrical charge to the electrostatic structure, and must always have a minimum energy and must detect the maximum capacitance. This causes significant electrical losses, and makes the system highly complex.

The use of electrets to permanently polarise the electrodes is also known. In this case it is no longer necessary to polarise the structure at each cycle; there is no longer a requirement to manage the introduction and removal of charge. It will be recalled that an electret is an electrically insulating material which exhibits a near-permanent state of polarisation. It is in general achieved by dipole orientation or by charge injection. In particular an electret induces a permanent polarisation in a capacitive structure. It does not allow current to pass however.

In addition there are several types of electret-polarised energy recovery conversion structures in existence. These different types are described in the document “Microstructures électrostatiques de récupêration d'énergie vibratoire pour les microsystémes”, S. BOISSEAU, G. DESPESSE J-J CHAILLOUT and A. SYLVESTRE, in Techniques de l'ingénieur, 10-2010, RE 160, pages 1-12.

The first type is an out-of-plane structure. An electrode and a counter-electrode are arranged so that they are facing each other, one carrying the electret. Both electrodes are designed to be brought together and moved apart from each other and between them define a variable gap. The assembly forms a variable capacitance condenser.

This is a particularly suitable structure if the vibrations are known and are stable over time (in terms of frequency and of amplitude). The design dimensions of the structure are thus chosen so that the reference vibrations produce a maximum variation in capacitance: the counter-electrode oscillates between a position which is very close to the electret and a position of high separation. This structure however exhibits a drawback in that in the event of the vibrations being too strong, the counter-electrode can touch the electret, which may release the charge stored in the electret and reduce the working life of the electret and therefore of the structure.

The second type of structure is the in-plane structure, which uses structured electrets. In this structure, the electrode and the counter-electrode define a set gap, but the counter-electrode moves in a single plane parallel to the electrode. The facing surface areas vary. In order to increase the variation in the capacitance, the electret, electrode and the counter-electrode are textured; for example the electrode and the counter-electrode are in the form of parallel strips inclined in relation to the direction of movement of the counter-electrode, with the electrode strips and covered with the electret. Thus there is a large variation in surface area and a significant variation in capacitance therefore results from this. These structures are, however, more difficult to develop and their manufacturing costs are higher than those of out-of plane structures.

Furthermore the working life of the system is dependent on the stability of the electret. If the electret becomes discharged then the system no longer functions. The stability of the electret may be significantly reduced when it is subjected to difficult conditions, such as for example humidity greater than 30% and a temperature in excess of 100°. Many systems are occasionally exposed to these types of conditions, and in particular during their manufacture. Moreover, there are few materials capable of retaining their charges over long periods; these are mainly polymers such as Teflon®, Kapton®, Mylar®, CYTOP® and ceramics based on oxides (SiO2) or silicon nitride (Si3N4).

Document U.S. Pat. No. 4,126,822 discloses a system which generates electricity electrostatically, but which requires pre-charging of the electrodes and requires that the charge be maintained by complex polarisation means.

The document “Flexible Triboelectric Generator”, Feng-Ru Fan, Zhong-Qun Tian, Zhong Lin Wang, Nano discloses a device for energy recovery using the triboelectric effect which does not recover large amounts of energy and which is furthermore if little practical use.

### PRESENTATION OF THE INVENTION

One purpose of the present invention is consequently to offer an energy recovery system wherein the problems of contact and of stability of the electret charge do not arise.

The purpose of the present invention is achieved by a device for recovering mechanical energy comprising at least one first assembly comprising a conductive element covered with a dielectric material, and a second assembly comprising at least one conductive element, the two assemblies being able to move relative to one another, where the dielectric material and the second assembly exhibit different triboelectric affinities. The device is such that the second assembly and the dielectric make contact, the effect of which is to charge the dielectric. In one embodiment the energy is recovered between the conductive element of the first assembly and the conductive element of the second assembly. In another embodiment the energy is recovered either on one of the assemblies which includes several conductive elements, or on both assemblies separately.

The charge of the dielectric is then maintained due to the contact with the second assembly.

Thus it is not necessary to use a material which is designed to maintain its charge over long periods, since it is “recharged” during operation.

Moreover the device becomes capable of indefinite use since the dielectric is never discharged.

Finally, any contact between the second assembly and the dielectric no longer poses a problem; on the contrary it is desirable. Therefore an out-of-plane structure can be used, the construction of which is simpler and cheaper than in-plane structures.

This device has the advantage of not requiring the application of a potential difference between its conductive elements in order to operate.

In other words, the effects of the electrostatic charges that may accumulate in the dielectric material through the triboelectric effect can be used to produce electrical energy. State of the art devices, such as triboelectric generators or electrostatic induction machines which use triboelectricity, directly collect the charges produced during contact. On the contrary, according to the invention these charges are not collected directly, but are used to transform a dielectric material into an electret or a pseudo-electret (i.e. which has a shorter working life than an electret as the term is commonly understood) through the triboelectric effect or to maintain the charge of an electret. Moreover, unlike electrostatic energy recovery devices wherein means are used to prevent contact between the fixed and moving parts, in the case of the device according to the invention contact between the fixed parts and the moving part is sought in order to recharge the dielectric material and to maintain polarisation.

The selection of materials of different triboelectric affinities and contact between these materials form means of maintaining the polarisation of the device.

This device offers the advantage of being completely autonomous since it requires no means of polarisation and its polarisation is maintained over time.

One subject-matter of the present invention is therefore a method for recovering energy by means of an energy recovery device comprising a first assembly and a second assembly placed facing each other and which can move relative to each other, the first assembly comprising at least a first conductive element and a first dielectric element carried by the first conductive element, and the second assembly comprising at least a second conductive element, said first dielectric element being arranged between the first conductive element and the second conductive element, said first dielectric element being able to make contact with a part of the second assembly, where the material of the first dielectric element and the material of the part of the second assembly with which the first dielectric element makes contact exhibit different triboelectric affinities, the method having the following steps:
pre-charging of the first dielectric element of the first assembly, the charge on this first dielectric element being fully or partly produced by a triboelectric effect at the time of the contact made by the first dielectric element and an element of the second assembly called the contact element;
relative movement of the first and second assemblies between a first position called the contact position, for which the first pre-charged dielectric element is in contact with said contact element of the second assembly and exhibits a first contact surface area, and a second position called the separated position, for which said contact element of the second assembly is separated from the first dielectric element, so that they are no longer in contact or so that they exhibit a second contact surface area which is less than said first contact surface area, this movement inducing a variation in capacitance between the first dielectric element of the second conductive element;
flow, during said movement, of a current between the first conductive element of the first assembly and an electrical circuit, this current being induced by said relative movement of the first and second assemblies and inducing electrical energy in the electrical circuit.

Very advantageously, the variation in capacitance between the first dielectric element and the second conductive element at the time of said movement is equal to at least 20%, preferably equal to at least 40% of the capacitance value in the so-called contact position.

The recovery method according to the invention may comprise, in the contact position, a first equilibrium state which occurs between the first conductor, the first dielectric element and the second conductive element, and in a separated position a second equilibrium state which occurs between the first dielectric element and the first conductive element, where the change from the first equilibrium state to the other causes an electrical current to flow between the first conductive element of the first assembly and the electrical circuit.

In addition another subject-matter of the present invention is a device for recovering energy comprising a first and a second assembly placed facing each other and which can move one relative to the other, the first assembly comprising at least one first conductive element and a first dielectric element carried by the first conductive element, and the second assembly comprising at least one second conductive element, said first dielectric element being arranged between the first and second conductive element, said first dielectric element being able to make contact with a part of the second assembly, the material of the first dielectric element and the material of the part of the second assembly with which the first dielectric element makes contact exhibiting different triboelectric affinities, the first dielectric element of the first assembly being designed to exhibit a charge fully or partly obtained by a triboelectric effect at the time the first dielectric element makes contact with an element of the second assembly called the contact element, where the device allows relative movement of the first and second assemblies between a first so-called contact position, for which the first pre-charged dielectric element is in contact with said contact element of the second assembly and exhibits a first contact surface area, and a second so-called separated position, for which said contact element of the second assembly is separated from the first dielectric element so that they are no longer in contact or such that they exhibit a second contact surface area which is less than said first contact surface area, this movement inducing a variation in capacitance between the first dielectric element and the second conductive element, the device comprising in addition an electrical circuit connected to the first conductive element such that an electric current is designed to flow, during said movement, between the first conductive element of the first assembly and the electrical circuit, this current being induced by said relative movement of the first and second assemblies and inducing electrical power in the electrical circuit.

In one embodiment, the electrical circuit connects the first conductive element and the second conductive element.

In one example, the second conductive element may form the part of the second assembly with which the first dielectric element makes contact.

In another example, the second assembly comprises a second dielectric element carried by the second conductive element and arranged between the first dielectric element and the second conductive element, the second dielectric element forming the part with which the first dielectric element makes contact.

In another embodiment, the device for recovering energy may comprise a first and a second assembly facing each other, wherein the first assembly comprises at least one pair of adjacent conductive elements each of which is covered by a dielectric element, both dielectric elements having different triboelectric affinities, and the second assembly comprising at least one second conductive element having a triboelectric affinity which is between the triboelectric affinities of the two dielectric elements of the first assembly, wherein the electrical circuit links the two or more conductive elements of the first assembly.

The second assembly may be formed by a conductive element covered with a dielectric element.

In another example of an embodiment, each of the first and second assemblies comprise at least one pair of two adjacent conductive elements, each covered by a dielectric element, the two dielectric elements of each pair having different triboelectric affinities, and where the facing dielectric elements have different triboelectric affinities. The means of collecting the electrical energy generated collect the electrical energy generated between the conductive elements of each pair.

In another example of an embodiment, each of the first and second assemblies comprise at least one pair of two adjacent conductive elements, each covered by a dielectric element, the two dielectric elements of each pair having different triboelectric affinities, and where the facing dielectric elements have different triboelectric affinities, the conductive elements of the second assembly being short-circuited.

The first and second assemblies may be flat and may be parallel, at least one of the first and second assemblies being mounted on a frame so that it moves at least perpendicularly to the other conductive assembly.

The first and second assemblies may be flat and may be parallel. The first assembly may be structured and the second assembly may be structured so that at the time of movement of the first and/or of the second assembly along a direction parallel to the first and second assemblies, a variation is capacitance is produced between the one or more dielectric element of the first assembly and the second assembly.

In one example of an embodiment the first and/or the second assembly comprise a plurality of wires each comprising a core and an envelope, where the core forms a conductive element and the envelope forms a dielectric element. The wires may be woven.

In one embodiment, at least the second assembly may be flexible, so that it moves closer to the first assembly due to the effect of an external force and so that it makes contact with the first element when said external force exhibits sufficient intensity.

For example, the first and the second assembly are held by a support, said support being such that it deforms elastically to move the first assembly closer to the second assembly due to the effect of an external force and brings them into contact when said external force exhibits sufficient intensity.

The first assembly may have a shape which is curved in the absence of an external force being applied, and at a distance from the second assembly, where said first assembly is deformed by the application of an external force and makes contact with the second assembly.

In another embodiment, both assemblies are permanently in contact.

According to an additional characteristic, the one or more dielectric elements are compressible.

In one embodiment example, at least one of the assemblies may have a rotational movement around an axis of rotation. In one embodiment, the first and second assemblies may be disk-shaped, with at least one of the assemblies being able to rotate around its axis, where the axes of the first and second assemblies are secants, where both assemblies are permanently in contact by their edges, with the disk of the first assembly being divided into angular sectors, where some angular sectors are covered by some first dielectric element and where some angular sectors are not covered by first dielectric element.

In another embodiment, the first and second assemblies may be parallel, with the first assembly being disk-shaped and being divided into angular sectors, with some first angular sectors being covered by the first dielectric element and some second angular sectors being covered or not by the first dielectric element, where the first angular sectors are permanently in contact with the second assembly. The second assembly may therefore be disk-shaped, with the axes of the disks coinciding with the axis of rotation.

The second assembly may be capable of rotation and have the form of an angular section which rotates around the axis of rotation.

Another subject-matter of the present invention is a system comprising at least two devices for recovering energy according to the present invention, connected in parallel or in series.

Another object of present invention is a system comprising at least one device for recovering energy according to the present invention and means for storing the recovered energy before it is transferred to the user circuit.

The system may comprise at least one communication sensor capable of carrying out a measurement, processing it and transmitting it by radio means to a receiver once the amount of energy stored in the means of storage is greater than a given threshold.

Another subject-matter of the present invention is a garment comprising at least one device according to the present invention or a system according to the present invention where the first assembly and the second assembly are carried by two pieces of the garment which face each other and which are designed to move relative to one another and to make contact, where the two parts for example are formed by two trouser legs.

Another subject-matter of the invention is a tyre for an automotive vehicle comprising at least one recovery device according to the present invention or a system according to the present invention, where one of the assemblies of the device is fixed to an internal face of a tread of the tyre.

The tyre or the garment may comprise means for processing the variation in the current or in the electrical voltage recovered as a function of time in order to determine information about the tyre, such as the speed of rotation, the pressure, the temperature or acceleration or the relative movement of the parts of the garment.

### BRIEF DESCRIPTION OF THE DRAWINGS

The present invention will be better understood by means of the description which follows and the appended illustrations, in which:

FIGS. 1A and 1B are schematic side views of an example of a first embodiment of a system for recovering energy in two operational states,

FIGS. 2A and 2B are schematic side views of another example of the first embodiment of a system for recovering energy in two operational states,

FIG. 3 is a schematic section view of another example of an embodiment of a recovery device according to the first embodiment, in the form of wires,

FIG. 4 is a schematic side view of an example of a device for recovering energy according to a second embodiment,

FIG. 5 is a schematic side view of another example of a device for recovering energy according to the second embodiment,

FIG. 6 is schematic view of a variant of the device in FIG. 5,

FIG. 7 is another example of an embodiment of the first embodiment wherein the assemblies are structured,

FIGS. 8 to 11 are examples of embodiments of the recovery device according to the invention, where the two assemblies have a relative rotational movement,

FIG. 12 is a schematic side view of an example of an embodiment of a device for recovering energy, wherein the dielectric elements are compressible,

FIG. 13 is a schematic representation of a tyre to which a device according to the invention may be applied,

FIG. 14 is a graphical representation of the radial acceleration of a point on the surface of the tyre as a function of time,

FIG. 15 is a graphical representation of the variation in electrical current recovered by a device according to the invention mounted in a tyre, as a function of time,

FIGS. 16, 17, 18A and 18B are schematic side views of the various examples of embodiments of the device structure in FIGS. 1A and 1B, particularly suited to the recovery of energy in a tyre,

FIG. 19 is a schematic representation of a garment equipped with a recovery device according to the invention,

FIG. 20 is a schematic representation of a device applied to a sweater.

### DETAILED DESCRIPTION OF SPECIFIC EMBODIMENTS

In the following description the same references will be used to describe the elements which have substantially the same form and function in all the embodiment examples.

In the present application, the term “electrical capacitance between a conductive element and a charged dielectric element” means the equivalent capacitance relative to the conductive element that charges the electrical charges stored in the dielectric element. If, for example, the charges are stored at a certain depth of the dielectric element, the equivalent capacitance is the capacitance that would form an electrode placed at this depth in relation to the conductive element. In practice charges may be stored at different depths in the dielectric element. The electrical capacitance between a conductive element and a charged dielectric element therefore means an overall equivalent capacitance which charged with the surface potential of the electret would store the same amount of energy as the total electrical energy which is stored in the form of distributed electrical charges (½C_{eq}V_{surface}²=Σ½Q_{elementary}V_{associated}−V_{associated} being the potential difference between each of the implanted charges Q_{elementary} and the conductive element).

Moreover, in the present application, the term “electrical capacitance between two charged dielectric elements” means the equivalent electrical capacitance that differentially charges the electrical charges stored in the two dielectric elements. The interaction energy between the charges stored in each of the two dielectric elements is substantially equal to ½Q²/C_{equivalent} where Q² is the difference in charge between the first and second dielectric elements and C_{equivalent} is the electrical capacitance between two charged dielectric elements).

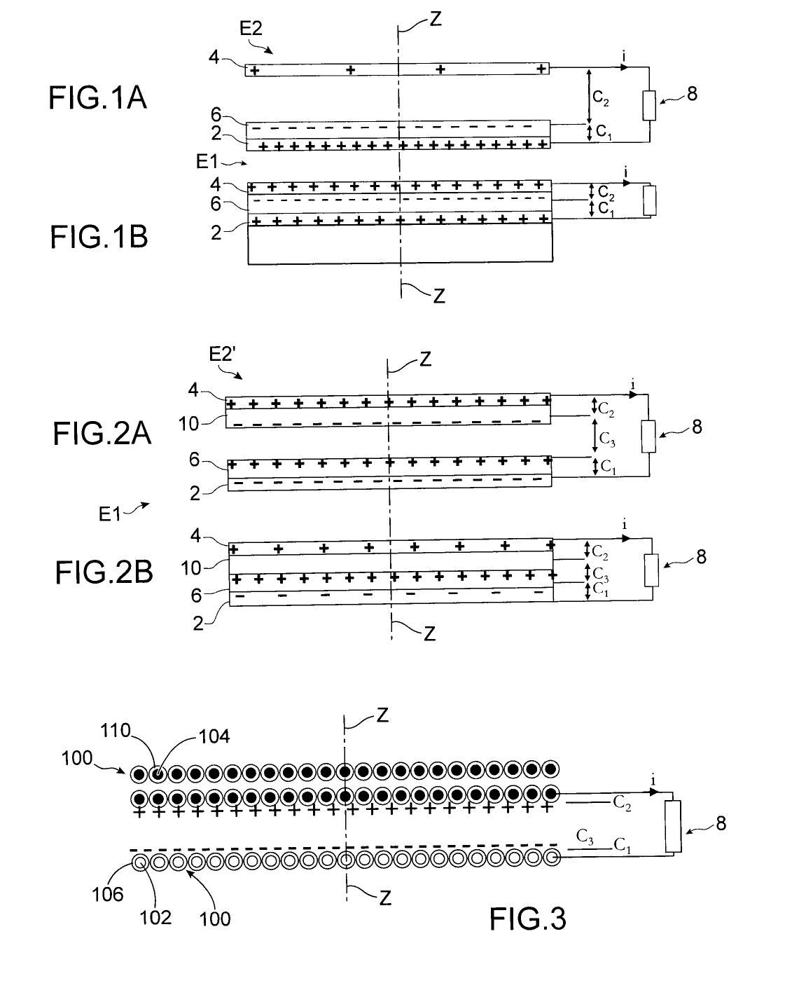

FIGS. 1A and 1B show a first example of a system for recovering energy according to a first embodiment, comprising a first assembly E1 and a second assembly E2 arranged facing each other. The first assembly E1 comprises a first conductive element 2 which is plate-shaped, covered with a first dielectric element 6, and the second assembly E2 comprises a second conductive element 4 which is plate-shaped. The dielectric element 6 is located between the first 2 and second 4 conductive elements.

The first 2 and the second 4 conductive elements are electrically connected through a circuit 8 which consumes electricity and which is, for example, a lamp, a sensor, a battery charger etc., or a storage device of the battery type.

The first assembly E1 and the second assembly E2 are such that they are designed to move closer to each other and move away from each other along the axis Z due to the effect of an external action, for example vibrations or deformation. For example, only the second element E2 is able to move along the axis Z and is suspended, for example by springs, on a support (not shown) in relation to which the first assembly E1 is fixed.

The device is such that the amplitude of movement of the second assembly E2 relative to the first assembly E1 is significant, i.e. the movement of the second assembly E2 is sufficient to allow the second conductive element 4 to come into contact with the first dielectric element 6. The variation in the capacitance is preferably at least 20% and more preferably at least 40%. Advantageously the variation in the gap between the two dielectrics is at least 10 μm, so as to create a variation in capacitance of at least 20%, and advantageously at least 50 μm so as to create a variation in capacitance of, advantageously, at least 40%.

A device wherein both assemblies would be able to move along the axis Z and a device wherein only the first assembly comprising the first conductive element and the dielectric element would be able to move still falls within the scope of the present invention.

The material of the dielectric element 6 and the material of the second conductive element 4 are selected so that they exhibit different triboelectric affinities, i.e. when the two materials make contact they exchange electrons, with the one having a tendency to give up electrons whilst the other has a tendency to pick up electrons. The materials are categorised according to their ability to give up or to pick up electrons, in a list called a “Triboelectric series”, one example of which is given below.

Materials with a positive affinity

Dry hands
Rabbit fur
Glass
Hair
Nylon
Wool
Cat's fur
Lead silk
Aluminium
Paper
Cotton
Steel, stainless steel
Wood, amber, resin
Sulphur
Hard rubber (ebonite)
Nickel, copper,
Brass, silver,
Gold, Platinum
Polyester
Polystyrene
Polyurethane
Polyethylene
Polypropylene
Poly vinyl chloride
Silicone
Teflon

### Materials with a Negative Affinity

The use of elements which are close to each other in the triboelectric series can be envisaged, but it is advantageous to select materials which are far apart from each other in the series, so that the exchange of electrons whenever contact is made is facilitated. The positive or negative affinity of a material is defined relative to another material.

In the example shown, the material of the second conductive element is chosen such that it exhibits a tendency to give up electrons, and the material of the dielectric element is chosen such that it has a tendency to pick up electrons. Thus the electrons picked up or pulled off will be trapped in the material of the dielectric element. The presence and absence of electrons are represented by − and + signs respectively in FIGS. 1A and 1B. Conversely, it is also possible to select another pair of materials such that the dielectric provides the electrons which are then picked up by the metal.

During the manufacture of the device, the dielectric element may be uncharged and may be charged during the operation of the device after the first contact with the second conductive element 4, with the dielectric element being recharged at each contact. According to a variant, the dielectric element is already charged and this is then an electret. Its charge is maintained by contact with the second conductive element 4. Indeed the electret can lose charge over time, for example due to auto-discharging effects in the material. In some cases contact between an electret and a conductor may also lead to a loss of charge of the electret: the charge from the electret may pass into the conductor. By choosing materials which exhibit different triboelectric affinities such a problem is avoided. Pairs are preferably chosen which are as far apart as possible in the triboelectric list, so as to maximise the effectiveness of the energy recovery system. For example, the following pairs may be chosen: Gold/Teflon, Lead/Teflon, Brass/Nylon, Aluminium/Teflon etc.

We will now explain the operation of the energy recovery device in FIGS. 1A and 1B.

We will consider the case where the dielectric element 6 is initially already charged with a charge Qi. The charge Q2 is the charge induced by the charged dielectric element on the first conductive element 2 and the charge Q4 is the charge induced by the charged dielectric element 6 on the second conductive element 4. According to the law of conservation of charge Qi=Q2+Q4.

There exists a capacitance C1 between the dielectric element and the first conductive element 2, and a capacitance C2 between the dielectric element 6 and the second conductive element 4.

The second conductive element 4 is made to vibrate by an external event, and it moves along the axis Z, moving closer to and away from the dielectric element 6. The electrostatic effect exerted by the charges of the dielectric element 6 on the first 2 and the second 4 conductive elements varies over time as a function of the distance separating the charged dielectric element 6 and the second conductive element 4. This results in a new distribution of charge between the conductive elements 2 and 4.

When the second conductive element 4 is far away from the dielectric element 6 (FIG. 1A), the assembly formed by the first conductive element 2 and the dielectric element tends to become neutral and the capacitance C1 is much greater than the capacitance C2.

Then, when the second conductive element 4 moves closer to the dielectric element 6 it falls under the electrostatic influence of the charged dielectric element, and becomes charged, through the circuit 8, so as to balance the charge on the dielectric element, and the capacitance C2 becomes significant in relation to the capacitance C1. The variation in the influence of the dielectric element's charge on the second conductive element 4 is represented by the increase in the charge on the second conductive element in FIG. 1B (FIG. 1B shows a level of charge on the electrode 4 which is greater than the charge on the electrode 4 in FIG. 1A before electrode 4 moves closer to electrode 6.

A redistribution of charge has therefore taken place between the first 2 and the second 4 conductive elements through the circuit 8, which produces an electric current through the circuit 8 and an electrical voltage at its terminals. A portion of the mechanical energy which caused the second conductive element to move is thus converted into electrical energy.

The second conductive element 4 comes into contact with the charged dielectric element 6 (FIG. 1B) and as a result of their different triboelectric affinities, they exchange charge, more specifically in the example shown the second conductive element 4 gives up electrical charge and the dielectric element 6 picks up electrical charge. The charge on the dielectric element is thus maintained over time and the energy recovery device remains operational. The contact between the dielectric element 6 and the second conductive element 4 may take place due to a movement which is primarily along the Z axis. It may be envisaged that the second conductive element 4 and the dielectric element slide against each other in a direction perpendicular to the Z axis.

The charge (electrons or missing electrons (holes)) picked up by the dielectric element remains primarily on its surface. It should be noted that an electret charged or re-charged by triboelectricity is of poor quality in comparison with a “standard” electret. It generally has low stability for a variety of reasons, in particular because the charge remains somewhat localised on the surface. However, due to the device according to the invention, the latter is recharged regularly by rubbing, so the poorer quality has no effect on the effectiveness and working life of the system. Besides, this electret can be of lower cost than electrets which are capable of retaining their charge over long periods; moreover there is a greater choice of usable materials available.

This example of an embodiment possesses small dimensions, so it is thin. Each conductive element may be formed of an aluminium film, with the first conductive element being covered with Teflon. The thickness of the conductive elements is, for example, between 100 nm and 10 mm. The thickness of the dielectric is for example between 10 nm and 1 mm.

The contact made between the dielectric element 6 and the second conductive element 4 is random overall. The design dimensions of the system, however, are such that contact between the dielectric element 6 and the conductive element 4 takes place at a sufficient frequency to allow the dielectric element to be recharged, for example at least once a day, for example at the time of maximum travel between the dielectric element 6 and the conductive element 4.

Due to triboelectric effects, the dielectric element has a natural tendency to become charged to a maximum value which is proportional to the difference in triboelectric affinities. Thus the quantity of charge present in the dielectric element very advantageously does not need to be precisely controlled in practice. The order of magnitude of this quantity is the mC/m², and may reach up to a maximum of 10-15 mC/m².

FIGS. 2A and 3B show another example of an embodiment according to the first embodiment of an energy recovery device. This device differs from that in FIGS. 1A and 1B, in that the first and the second conductive elements are each covered with a dielectric element.

The device in FIGS. 2A and 2B comprise a first assembly E1 and a second assembly E2′. Each assembly comprises a first conductive element 2 and a second conductive element 4 arranged facing each other at a distance designed to vary due to the effect of an external event. In the example shown, only the second conductive element is able to move along an axis Z.

The first conductive element 2 and the second conductive element 4 are respectively covered with a first 6 and a second 10 dielectric element. The first and second dielectric elements are thus arranged facing each other.

The materials of the first 6 and second 10 dielectric elements are chosen such that they exhibit different triboelectric affinities. One of the materials has a tendency to give up electrons whilst the other material has a tendency to pick up electrons. In the example shown, it is the material of the second dielectric element 10 which has the tendency to pick up electrons and the material of the first dielectric element 6 which has the tendency to give up electrons. The presence and the absence of charge (electrons) are represented by the signs − and + in FIGS. 2A and 2B. For example, the first dielectric element is made of Teflon and the second dielectric element is made of nylon or wool.

The first 2 and the second 4 conductive elements are electrically connected by a circuit 8 which consumes electricity.

A capacitor with a capacitance C1 is thus formed between the first conductive element 2 and the first dielectric element 6, a capacitor with a capacitance C2 is formed between the second conductive element 4 and the second dielectric element 10, and a capacitor of capacitance C3 is formed between the first 6 and the second 10 dielectric elements.

In this example of an embodiment, the second assembly E2′ is able to move relative to the first assembly E1. The construction allowing the second assembly E2′ to move is such that the movement is sufficient to allow the first 6 and second 10 dielectric elements to come into contact, allowing an exchange of electrons to take place.

As described for the example of embodiment in FIGS. 1A and 1B, the first dielectric element 6 and/or the second dielectric element 10 may be charged beforehand.

We shall now explain the operation of this device.

The movement of the second assembly E2′ relative to the first assembly E1 results in a variation in the capacitance C3 between the charges stored on each of the dielectric elements 6, 10. When the two assemblies E1, E2′ are far apart, each assembly E1, E2′ has a tendency to become neutral, and the capacitances C1 and C2 are much greater than capacitance C3. When the assemblies E1, E2′ move closer together, they come under each other's influence and tend to balance each other out. The charges stored in the conductive elements are then partly removed in order to balance out, with the excess electrons from one of the conductors then overcoming the deficit in electrons in the other conductor via a flow of current through the circuit 8.

Each time that the dielectric elements 6, 10 come into contact, electrons are pulled off the first dielectric element 6 and are picked up by the second dielectric element 10.

This example of an embodiment has the advantage of offering a greater choice of pairs of materials with different triboelectric affinities in order to create dielectric elements. For example nylon could be chosen for the first dielectric element and polypropylene for the second dielectric element.

FIG. 3 shows another example of a recovery device according to the first embodiment, wherein instead of being in the form of plates facing each other the first and second assemblies are each formed of a plurality of wires.

Each assembly comprises a plurality of wires 100, where each wire 100 of the first assembly comprises a core 102 made of an electrically conductive material and an envelope made of dielectric material 106 and where each wire of the second assembly comprises a core 104 made of an electrically conductive material and an envelope made of dielectric material 110.

The wires of each assembly are arranged side by side and the conductive cores are electrically connected to each other in series or in parallel. In the representation the wires are arranged parallel to each other, but an embodiment wherein the wires would not be arranged in a strictly parallel manner would still fall within the scope of the present invention.

As in the device in FIGS. 2A and 2B, the materials of the envelopes of each assembly are selected so that they exhibit different triboelectric affinities.

Capacitors of capacitance C1 and C2 are formed between the cores 102 and the envelopes 106, and between the cores 104 and the envelopes 110 of the wires of the first and second assemblies respectively, and a capacitor of capacitance C3 is formed between the envelopes 106 and 110 of the first and second assemblies.

The operation of this device is similar to that of the device in FIGS. 2A and 2B.

This device is particularly suitable for the manufacture of textile. Weaving of the wires 100 may be envisaged. For example the wires 100 form weft yarns and conventional threads, for example made of cotton, form the warp yarns. The diameter of the conductive wire may be between 10 μm and 300 μm. The thickness of the dielectric envelope may be between 10 nm and 1 mm.

A textile structure can also be envisaged, woven from threads as described above in order to make a garment such as a sweater, a shirt or jeans etc. In the case of thick textile, for example more than 3 mm thick, these threads might only be used to make the layer of textile which comes into contact with the second assembly in order to maximise the capacitance.

The creation of a textile using these wires directly has an advantage over a textile formed of a sheet of conductive material deposited on the rear surface of a conventional fabric of the order of 1 mm thick, since in the former electrical conductors are located much closer to the friction zone which is electrically charged, thus achieving a greater electrical capacitance relative to this charge.

A device comprising an assembly formed of wires as described above and an assembly formed of a plate as described in relation to FIG. 1A, 1B or 2A and 2B still falls within the scope of the present invention.

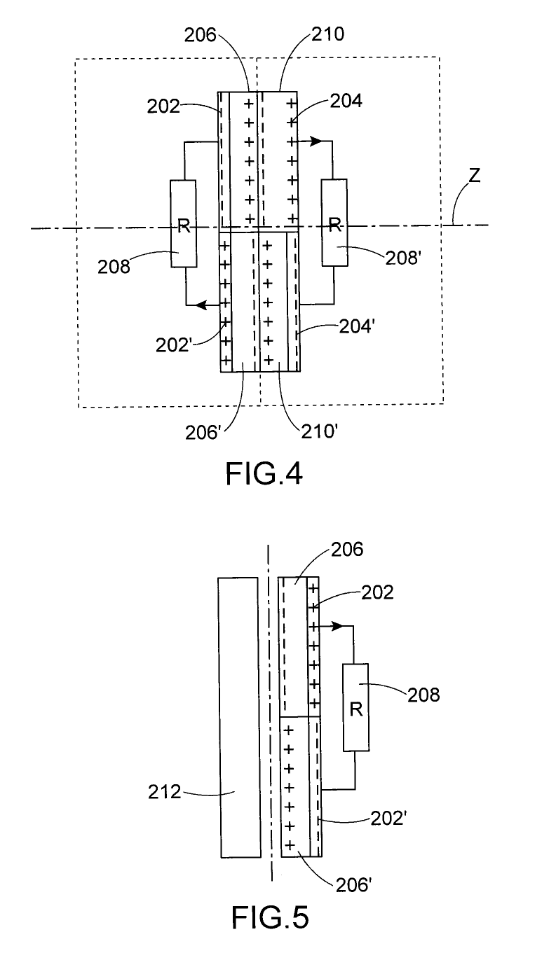

FIG. 4 shows an example of a device according to a second embodiment, wherein the two assemblies facing each other are not electrically connected.

The device in FIG. 4 comprises two assemblies which can move relative to each other, for example by moving away along the axis Z.

The first assembly comprises two conductive elements 202, 202′ insulated from each other and each covered with a dielectric element 206, 206′. The two conductive elements 202, 202′ covered with a dielectric element 206, 206′ are arranged next to each other and are firmly attached to each other.

The second assembly comprises two conductive elements 204, 204′ insulated from each other and each covered with a dielectric element 210, 210′. The two conductive elements 204, 204′ covered with a dielectric element 210, 210′ are arranged next to each other and are secured to each other.

The materials of the dielectric elements of a given assembly are chosen so that they exhibit different triboelectric affinities.

The two assemblies are arranged facing each other so that a dielectric element 206, 206′ is substantially opposite a dielectric element 210, 210′ respectively.

Moreover, the materials of the facing dielectric elements of the two assemblies are chosen so that they exhibit different triboelectric affinities. For example, the same dielectric material could be chosen for the elements 206, 210′ and the same dielectric material for elements 206′, 210.

The two conductive elements 202, 202′ and 204, 204′ of each assembly are electrically connected through a circuit which consumes electricity 208, 208′.

The operation of this device is similar to that of the device in FIGS. 2A and 2B, except for the fact that no current passes between the two conductive elements which can move relative to each other.

The number of conductive elements and of dielectrics element is not restricted to two, and may be greater than two.

According to a variant, it may be envisaged that energy is recovered from only one of the two assemblies, and for this the conductive elements of the other assembly would be connected so that they are short circuited. The energy recovered in one assembly is equal to the energy recovered in the configuration in FIG. 4. The integration of this device may be further improved by making structures in the form of wires as in the example in FIG. 3.

FIG. 5 shows another example of an embodiment of the second embodiment, comprising only one first assembly similar to the assemblies of the device in FIG. 4, which is arranged facing a third conductive element 212 which exhibits a triboelectric affinity which is between those of the two dielectric elements 206, 206′. If A1 represents the triboelectric affinity of the dielectric element 206, A2 the triboelectric affinity of the third conductive element 212 and A3 the triboelectric affinity of the dielectric element 206′, the values of the triboelectric affinities are ordered as follows:
A1>A2>A3 or A1<A2<A3

This means that when the third conductive element 212 comes into contact with the dielectric elements 206, 206′, it gives up electrons to the dielectric element 206 with affinity A1 and picks up electrons from the dielectric element with affinity A3. These charge states are represented by the signs − and +. Thus the two insulating elements 206, 206′ are of opposite charge, which implies that the conductive elements 202, 202′ are affected by opposite charges allowing electrons to flow when the third conductive element 212 moves relative to the first assembly and when the circuit is closed by a charge 8, as will be described below.

According to a variant, it may be envisaged that the conductive element 212 is covered with a dielectric element which will exhibit the triboelectric affinity between those of elements 206, 206′.

The energy is recovered from the first assembly.

The operation is similar to that of FIG. 4. When the conductive element 212 is at a distance from the first assembly, each dielectric element 206, 206′ is in equilibrium with the conductive element carrying it. When the third conductive element 212 comes closer, the dielectric elements 206, 206′ and the conductive element 212 influence each other. The transfer of electrons to balance the two conductive elements 202, 202′ takes place between the two conductive elements 202, 202′ via the electrical circuit which consumes energy 208. Energy is then gathered from the first assembly.

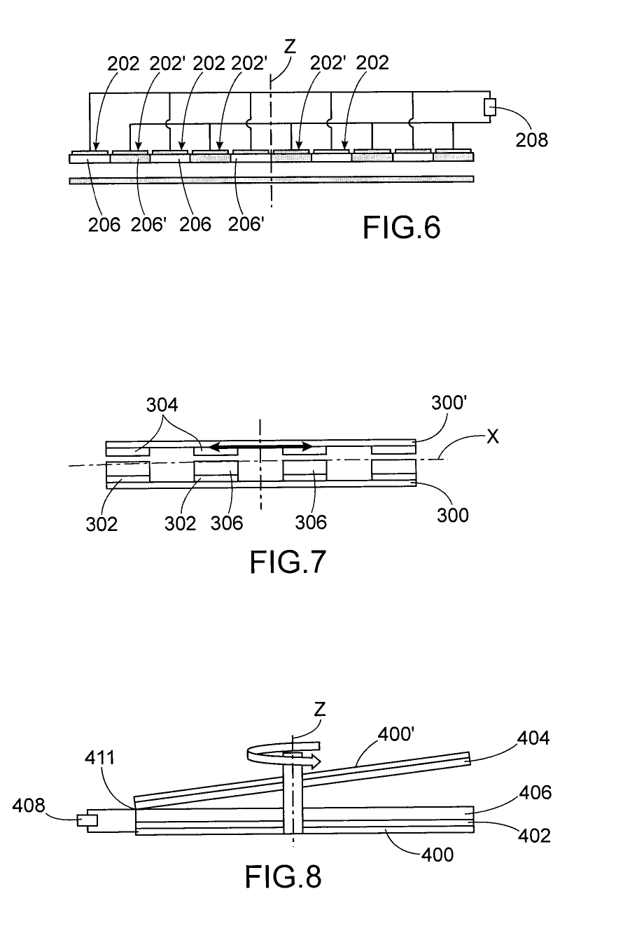

FIG. 6 shows an example of an embodiment wherein the first assembly comprises more than two conductive elements and more than two insulating elements. It comprises a system of dielectric elements 206, 206′ which have triboelectric affinities A1 and A3. In the example shown, all the conductive elements 202 which carry a dielectric element 206 with affinity A1 are connected together and all the conductive elements 202′ which hold a dielectric element 206′ with affinity A3 are connected together. The circuit 208 connects the conductive elements 202, 202′. According to a variant, it could be envisaged that one conductive element 202 is connected individually to a conductive element 202′ through a circuit.

This second embodiment is of particular interest, for example, for an application in the textile field, since it avoids the use of long fibres, with energy being recovered between two close electrodes. For example in the case of the device in FIG. 4 being integrated into a sweater, the first assembly may be in a sleeve and the second assembly 2 may be located on the body of the sweater facing the first assembly located in the sleeve. It is therefore no longer necessary to pass a long wire between these two elements. The integration is therefore optimised.

FIG. 7 shows an example of an embodiment allowing energy to be recovered from relative movements along both the X axis and along the Z axis.

The first assembly comprises an insulating support 300 whereupon discrete conductive elements are made covered with a dielectric element 306 and the second assembly comprises an insulating support 300′ whereupon discrete conductive elements 304 are made. The movement along the X axis generates a variation in the capacitance of the capacitors formed by the facing conductive elements 302, 304 due to the variation in the facing surface area. The variation in the overlap is significant, thus generating a significant variation in capacitance. Preferably the variation in the overlap between the two assemblies is at least 20%, so as to produce a variation in capacitance of at least 20%, more preferably of at least 40% so as to produce a variation in capacitance of, advantageously, at least 40%.

The energy is recovered between the conductive elements 302 and the conductive elements 304. To do this all the discrete conductive elements 302 may be connected together and all the discrete conductive elements 304 may be connected together, or each or several conductive elements may be connected to one or more conductive elements 304 respectively through a circuit.

It may be envisaged that the conductive elements 304 are continually rubbing against the dielectric elements 306 to ensure that these dielectric elements are recharged, or that the contact is random.

Advantageously, the facing surfaces of these assemblies are flat, with the conductive elements and the dielectric elements emerging from the surfaces, thus facilitating friction.

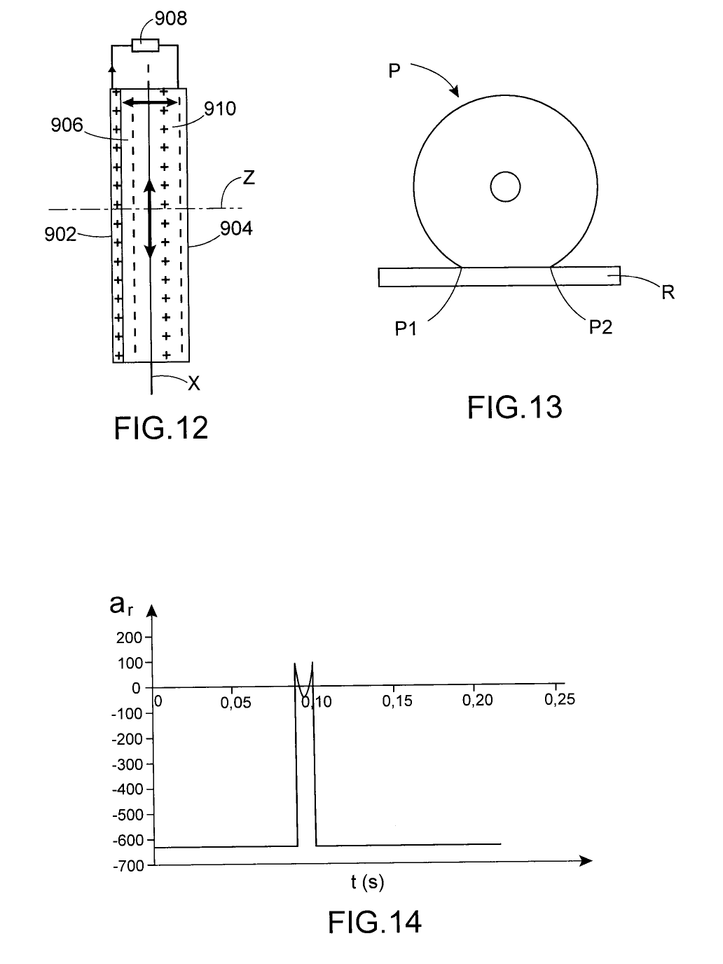

The creation of conductive elements may be envisaged whose shape allows energy to be recovered along three dimensions; the X, Z axes and a third axis perpendicular to axes X and Z. FIG. 12 shows a recovery device wherein the materials forming the dielectric element 906, 910 exhibit compressibility properties along the Z axis. The two dielectric elements 906, 910 are carried by conductive elements 902, 904 and are permanently in contact. The variation in the capacitance is a result of the compression of the dielectric elements due to movement along the Z axis and recharging of the dielectric elements is achieved by friction in the plane XY. This device is particularly suitable for an application in garments, for example in linings or in shoes, for example between the sole, added to the inside of the shoe, and the interior of the shoe.

FIGS. 8 to 11 show other examples of embodiments of the recovery device wherein both assemblies have a relative rotational movement.

In FIG. 8 the first assembly forms a stator comprising an electrically insulating support 400 and a conductive element 402 partly covered by a dielectric element 406. The second assembly forms a rotor which can rotate around an axis Z and comprises an insulating support 400′ and conductive element 404. The rotor is not parallel to the stator and is in contact with the latter at an edge 411 so that contact/friction between the conductive element of the rotor and one of the dielectric elements is achieved in order to recharge them. The conductive element 404 of the rotor and the dielectric element 406 exhibit different triboelectric affinities. The conductive elements 402, 404 are connected by an electrical circuit 408.

When the rotor turns, the capacitances of the capacitors formed between the conductive element 404 and the dielectric element 406 change. A flow of electrons occurs between the two conductive elements 402, 404 through the electrical circuit 408.

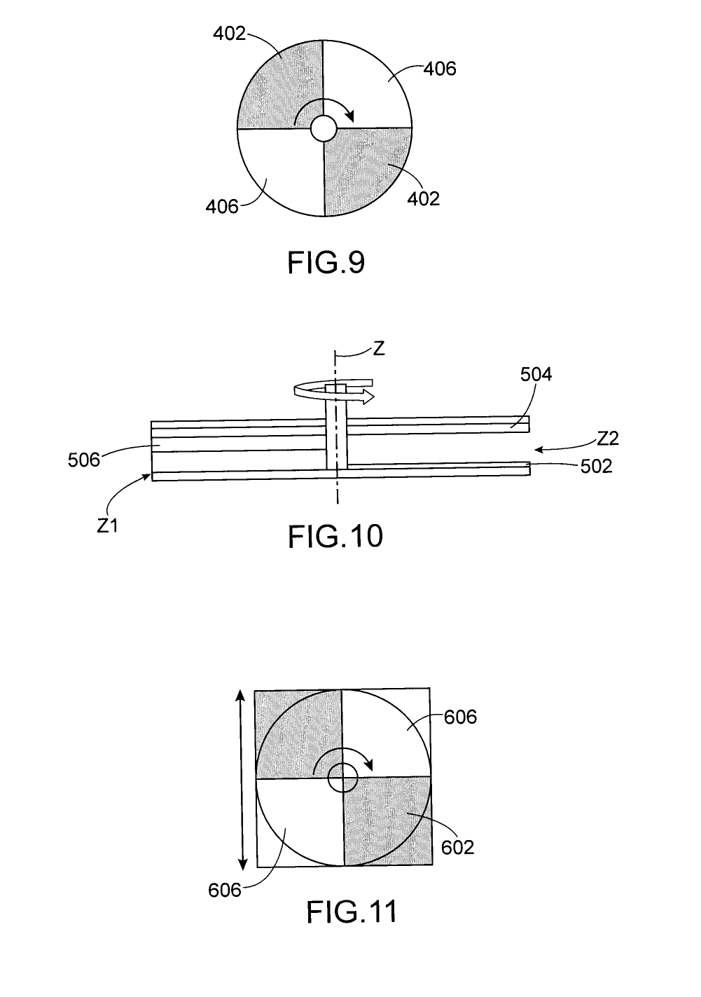

FIG. 9 shows, viewed from above, a stator wherein the face facing the rotor is cut into four quarters, with two non-successive quarters being covered with dielectric elements 406, the other quarters being formed by the conductive element 402.

It will be appreciated that the stator and rotor structures may be interchanged.

FIGS. 10 to 12 show another example of a rotation device embodiment. In this example the rotor is parallel to the stator. The rotor is similar to the rotor in FIG. 8. The stator comprises, for example, an angular zone Z1 of 180° made of a conductive element 502 covered with a dielectric element 506 in contact with the conductive element of the rotor 504, and an angular zone Z2 of 180° not covered with a dielectric element and wherein the conductive element may be thinner than the conductive element in zone Z1. Thus during rotation of the rotor, the conductive element 504 is in contact with the dielectric element 506 over the area of a half-disk, so that the capacitance is at a maximum, and the capacitance is at a minimum on the other half-disk. Furthermore, recharging of the dielectric element 506 takes place at the friction zone.

FIG. 11 shows another example of a rotary recovery device, comprising an eccentric rotor. The rotor forming the second conductive element 604 is shown in the example in the form of a quarter disk, so it has a centre of gravity which is eccentric in relation to the axis of rotation. The stator comprises a conductive element 602 in the form of a disk, two of whose zones, each of a quarter of a disk, are covered by a dielectric element 606, where the rotor is in contact with the dielectric elements 606 and this results in them being charged.

A rotary recovery device wherein the rotor would itself also comprise one or more dielectric elements would still fall within the scope of the present invention.

The output voltage of the recovery device is an alternating voltage, and is generally high, for example several tens or event hundreds of volts and the current that can be extracted is low, of the order of 1 μA. In order for it to be used by an electronic circuit, the electrical energy at the output from the energy recovery system is transformed into a lower voltage, for example a voltage of less than 10 V, for example 3V direct current.

An inductive converter, for example of the Flyback type could be used, for example. This is capable, with a maximum (in absolute value) voltage at terminals of the device, of transferring the electrical energy stored in the latter to means of energy storage, such as a capacitance, batteries or other means, acting as an energy buffer between the energy production device and the energy consumption circuit, where this storage system can, in particular, be used to stabilise the output voltage. In order to be able to use the energy recovered by the energy recovery system for an application, an intermittent mode of operation can be imagined, with storage in a buffer. For example, the means of storage accumulate the energy until the level of energy it is storing is sufficient to energise an electronic circuit, to allow it time to carry out a certain number of operations and to return it to stand-by.

The invention could thus be applied to the supply of communication sensors capable of carrying out a measurement, processing it and making a wireless transmission of it to a receiver. For example, a measurement of a physical parameter may be carried out, the measurement processed and sent by radio means once the level of energy stored in the means of storage reaches a certain threshold. If the storage system is of the capacitive type, its voltage will change as a function of its state of charge. In this case either the capacitance is over-dimensioned during design so that the measurement/processing/transmission only causes a small drop in the voltage, leaving the latter within the possible operating range of the electronics, or an additional converter is put in place at the output from the storage element to supply the electronics with a fully stabilised voltage when it is not on stand-by. As for the supply for the management electronics which detect the voltage maximum (in absolute value) at the terminals of the electrostatic structure and which generate the control signals for the transistors and/or the converters, it may be formed initially directly by the output from the energy recovery device via a bridge rectifier and a regulator, then once the terminal voltage of the storage element is sufficient, by the means of storage.

In addition, the energy recovery devices exhibit a low capacitance value, requiring a high inductance value with a low interference capacitance in order to achieve the transfer of energy from the recovery device to the means of storage. If the capacitance of the recovery device is made to be resonance with an inductance for a quarter of the resonance period in order to transfer the energy from this capacitance to the magnetic circuit of the inductance, then the flux in the magnetic circuit will undergo a variation at a frequency of 1/(2π√(LC)) which may be high if the capacitance is very small (<10 pF), which is the source of losses in the magnetic core and of high current levels in the inductance and in the electronic control switching system such as diodes. Advantageously a system is created which comprises several recovery devices in accordance with the invention, placed in parallel, with the devices being such that the appearance of capacitance maxima and minima between their conductive elements is relatively synchronised. The system therefore exhibits a higher capacitance value, and the energy losses during transfer between the device and the means of storage are thus limited.

We will now describe an application of the device in FIGS. 1A and 1B to the recovery of energy in an automotive vehicle tyre. The devices in FIGS. 2 to 7 may be applied in a similar manner.

The recovery of energy from the rotation of a tyre uses the variations in the acceleration in the tyre. FIG. 13 shows a schematic representation of a tyre P on a road R and upon which the various acceleration zones on the tyre are shown, and FIG. 14 graphically shows the radial acceleration in m·s⁻² of a point on the rolling surface of the tyre as a function of time.

It can be seen that during motion there are fairly sudden variations in radial acceleration aᵣ within the tyre, in particular between the radial acceleration present in the part of the tyre which is not in contact with the road and the more or less zero radial acceleration in the part in contact with the road between points P1 and P2.

The energy recovery device as shown in FIG. 1A is fixed to the internal part of the road tread of the tyre by its first conductive element 2. A mass is fixed to the second assembly so as to increase its sensitivity to centrifugal acceleration and consequently to increase the output power from the energy recovery system. The device moves with the tyre and experiences the variations in acceleration. The rapid variations in acceleration create the equivalent of impacts at the mass-spring structure (with the second conductive element 704 acting as a mechanical spring) which starts to vibrate at its resonance frequency after having moved once or more to its end of travel position. The presence of charge in the dielectric element 6 is then achieved by intermittent contact between the dielectric element 6 and the second conductive element 704.

This energy recovery device has a low cost price in comparison with existing ones, since it does not use expensive materials such as permanent magnets, copper or piezoelectric materials.

In addition, since mechanical contact between the two parts of the structure can be allowed to occur, the variations in the electrical capacitance are maximised and consequently the electrical energy produced in each cycle is maximised.

Moreover, energy can recovered irrespective of the driving speed, unlike in known devices which are made rigid to avoid the two parts making contact, thus preventing energy recovery at low speed.

Advantageously, the electrical energy thus generated may be used to supply sensors arranged in the tyres, for example pressure sensors.

The tyre may be equipped with several recovery devices distributed regularly within the tyre.

Very advantageously, it is possible to obtain information on the motion along the road from the characteristics of the current and voltage recovered.

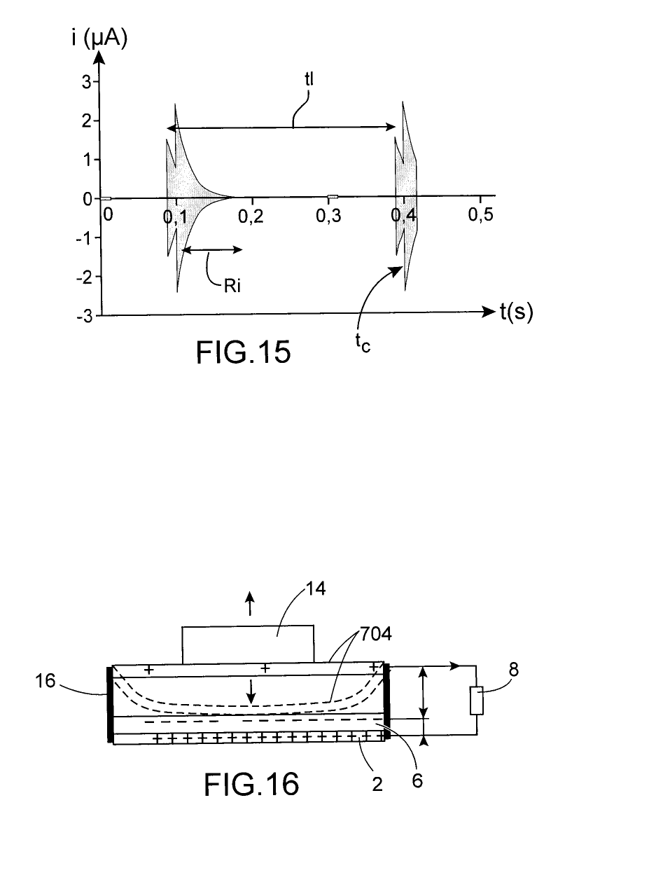

FIG. 15 shows the variation in the electrical current I, in μA, recovered in a tyre with a device as in FIGS. 1A and 1B according to the invention, as a function of the time t in seconds.

The information that it is possible to obtain about the motion on the road includes, for example, the length of the contact zone from measurements of the time that elapses between two neighbouring impacts, through tc in FIG. 15, i.e. the time that elapses between the time a point of the tyre comes into contact with the road and when it leaves the road surface, and the speed of rotation from the frequency of “separated” impacts, spaced out over time, designated by tl.

It might even be envisaged that pressure measurements could be obtained from the frequency and from the rate of decrease of the pulse response, designated by Ri. In effect, the greater the pressure then the greater the damping of the vibrating structure and the higher its oscillation frequency. The pressure can be deduced from oscillation frequency measurements.

FIGS. 16, 17, 18A and 18B show several examples of embodiments of device structures which allow the two assemblies of the device to move closer together and to move apart, specifically adapted for use in a tyre. It will be appreciated that these different structures may be applied in all fields and to any system that is suitable for setting at least one of the conductive elements in motion.

In FIG. 16 the device includes a rigid support 16 between the first conductive element 2 and the second conductive element 704. A mass 14 is firmly attached to the second conductive element 704. The second conductive element 704 is made in such a way that it deforms due to the action of radial acceleration when the zone of the tread in which it is fixed is not in contact with the road. Whilst deforming (the profile of the second conductive element 704 during deflection is shown in broken lines), the second conductive element 704 moves closer to the dielectric element 6. It then returns into position or begins to vibrate at its resonance frequency when the tread zone comes into contact with the road. The second conductive element 704 moves closer to and away from the dielectric element 6 and this generates a flow of electrons in the circuit 8. The second conductive element 704 randomly comes into contact with the dielectric element 6 and recharges it.

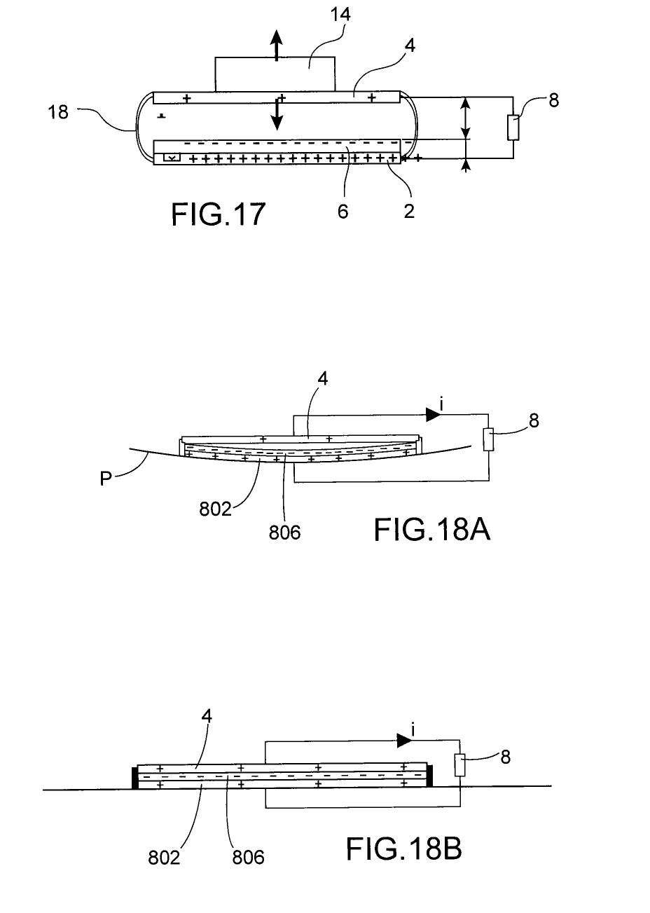

FIG. 17 shows another example of an embodiment, wherein the support 18 between the first 2 and the second conductive element 4 is flexible and when it undergoes deformation due to the effect of the centrifugal force the dielectric element 6 moves towards the second conductive element 4. A mass 14 is firmly attached to the second conductive element 4. The support 18 exhibits elastic properties to ensure that it returns to the at-rest position of the device in the absence of centrifugal force, i.e. when the zone to which the device is fixed is in contact with the road.

This device offers the advantage of being able to use rigid conductive elements in parallel motion, which maximises the variation in the capacitance. In effect, the facing surface areas which can move relative to each other are constant during motion; unlike in the device in FIG. 16 wherein the surface areas facing each other decrease when the second conductive element 704 undergoes deformation.

FIGS. 18A and 18B show another structure example. In this example the first element 802 has a curved profile which follows the shape of the tyre P, and is relatively flexible in order to follow the deformation of the tread. As for the second conductive element 4, it is rigid and flat. According to a variant, the second conductive element 4 is flexible and undergoes deformation, like the first element 802, in the presence of centrifugal acceleration, with the first element 802 itself being flexible and capable of following the shape of the tyre.

When the zone to which the device is fixed is not in contact with the road, the first conductive element 802 exhibits its curved profile, and the second conductive element 4 is therefore separated from the dielectric element 806 (FIG. 18A).

When the zone to which the device is fixed comes into contact with the road, the tread deforms and flattens, the effect of which is to make the first conductive element 802 substantially flat, so that it comes into contact with the second conductive element 4 via the dielectric element 806 (FIG. 18B). The capacitance is at a maximum when the zone to which the device is in contact with the road, unlike the devices in FIGS. 16 and 17.

In the embodiment where the second conductive element 4 is also flexible, the latter takes the same shape as the surface of the tyre in the presence of centrifugal acceleration and regains its original form in the zone of contact with the road, which corresponds to its at-rest state. Moreover, the second conductive element 4 may be convex in its at-rest state, so as to be further away from the first conductive element 802 in the at-rest state even if the first conductive element 802 has a tendency to flatten in the zone in contact with the road.

It will be appreciated that the various structures in FIGS. 16 to 18 may be combined: for example, a flexible support such as that in FIG. 17 could be associated with a flexible conductive element.

For example, the device may be adhered to the inside of the inner tube/chamber or incorporated directly into the tyre tread. Radial acceleration will tend to hold it in place by throwing it towards the exterior.

As has already been described above, the device according to the present invention may be applied to the textile industry and may be incorporated in garments to recover energy from relative motion of an individual's limbs, for example the movement between both legs or between the arms and the trunk, with the parts of garments covering these limbs rubbing against each other. According to the invention, advantage is taken of this rubbing to recharge the dielectric element or elements.

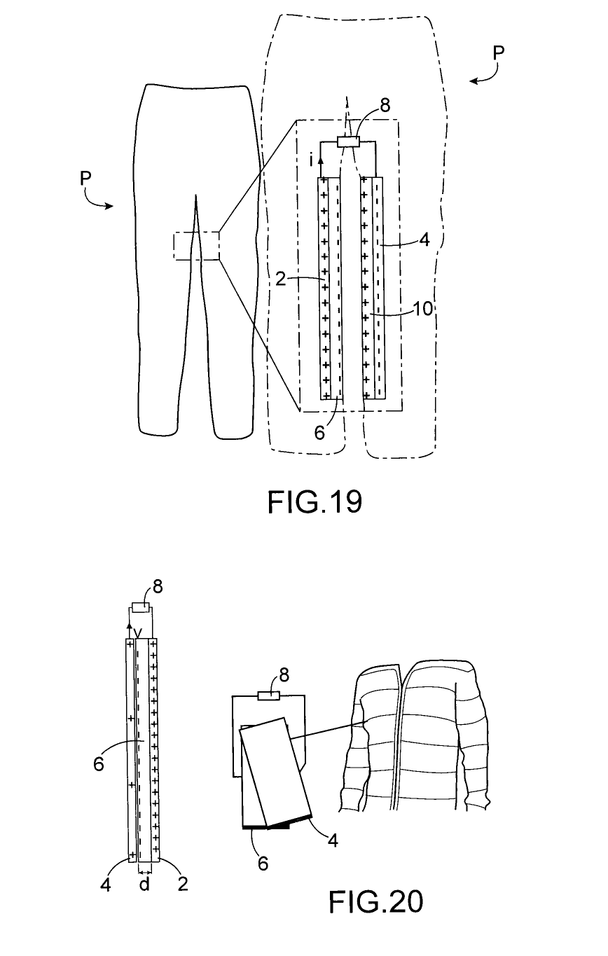

For example energy can be recovered from the relative movement of the legs which regularly move apart and then move closer together during walking, through the use of trousers equipped with a recovery device according to the invention. FIG. 19 schematically shows trousers P equipped with a recovery device according to the invention and which is that in FIG. 2A, but this is in no way restrictive. The trousers are reproduced in broken lines, and naturally the device is not to scale.

The trousers may comprise a leg with a first conductive element covered with a textile fabric which forms the dielectric element and a leg whose external surface is conductive, forming the second conductive element.

According to a variant, the trousers may comprise a leg with a first conductive element covered with a textile fabric with a high affinity for electrons, forming a dielectric element, and a leg with a second conductive element covered with an electron-donor textile fabric, forming another dielectric element. In this configuration, due to the rubbing and due to the textiles of different the triboelectric affinities, the transfer and therefore accumulation of the excess or lack of electrons on each of the legs is favoured. Several recovery devices may be fitted to the same garment.

As has already been described in the context of the second embodiment, the use of conductive wires with an envelope made of dielectric material means that conductive elements in the friction zone which is electrically charged can be brought closer together, thus allowing a greater electrical capacitance to be obtained for this charge. In addition, since the conductive elements are completely insulated, this embodiment protects the user from direct contact with the conductive elements when they are charged.

In a manner similar to the examples of application to the recovery of energy in a tyre, it is possible to develop structures with different geometries and which retain the same conversion principles.

Moreover, as in the case of application to tyres, it is possible to collect information on the movement of the individuals wearing the garment. For example it is possible to count the steps or the distance between the steps, for example by fitting the device to the leg, or to measure an individual's physical activity, for example in order to determine whether or not an older person is losing independence.

The energy recovery device may also be applied to different existing everyday devices, thus maximising the amount of energy collected. For example the device may be incorporated into the pages of a notebook or a book. As an example, some pages would contain within their thickness a flat conductive element and others would be conductive at the surface or would be made of another dielectric material with a different triboelectric affinity to that of the paper of the pages, for example of Teflon, or PVDF etc. and also contain an flat conductive element within their thickness.

According to a variant, the pages of the notebook would all be made of paper and the front or reverse face of each page would be a conductor. For example a layer of aluminium would be deposited on the reverse of each page. Recovery of energy can then be achieved between the conductive zones of the following pages, since the aluminium then tends to give up its charge and the paper tends to collect charge.

We will now give a numerical example in the case of application of the invention to a sweater, shown in FIG. 20.

It is possible to manufacture simple devices which comprise two aluminium plates or aluminium films and a Teflon film.

This device is fitted into a sweater in a zone located at the sides of the individual wearing the sweater so as to make use of the rubbing between the body of the sweater and the sleeves.

As a first approximation, the power output of this system is equal to P=V²·dC/dt where V is the surface potential of the electret and dC/dt the variation in capacitance of the structure, i.e. the variation of the electrical capacitance between the two conductive electrodes.

FIG. 20 shows the device attached to the sweater in a side view and in a front view.

In the example shown, the variation in capacitance is achieved through a variation of surface area by the lateral motion of the surfaces due to the swinging of the arms in relation to the body.

Let us assume that the electret has a thickness d equal to 100 μm, a dielectric constant of 2 (the case for Teflon) and a surface potential of 1000 V. The conductive element 4 and the dielectric element 6 have a common surface area S which depends on the position of the sleeve in relation to the body of the sweater and which will vary, for example, during walking.

Thus: C=∈∈₀S/d and dC/dt=(∈∈₀/d)×(dS/dt)

By assuming that the device has a surface area of 1 cm² and that the frequency of movement of the forwards and backwards swinging of the arms is 1 Hz, the output power is:

P=17.68 μW/cm².

If we take a device whose surface area is 1 dm², 100 times more power, namely 1.7 mW, can be recovered.

The power generated will be substantially the same if the mode of operation is considered with movements for making contact and for separation, for example by lateral separation and bringing together of the arms and the body.

Different examples of methods of production of a tyre equipped with a recovery device will now be described.

Due to the invention we can develop very simple structures for recovering energy to be applied to the tyre.

During a first step, a first assembly is made by depositing a layer of aluminium on a Teflon film. The layer of aluminium forms the first conductive element and the Teflon film forms the first dielectric element.

During a following step, the film of Teflon covered with aluminium is placed in a frame made of a plastic material, which holds the film in place and which allows contact to be made with the metallisation on the Teflon film, the frame being equipped with appropriate electrical contacts.

During a following step a sheet of aluminium forming the second conductive element of the second assembly is arranged in the frame and is positioned above the Teflon film whose rear face is covered with aluminium, such that an air gap is formed between the Teflon and the sheet of aluminium.

During a following step a mass is adhered to the sheet of aluminium.

The first and second conductive elements are then connected to an electronic circuit.

Finally the complete system is encapsulated and incorporated into the tyre.

We shall now describe two examples of a method for producing a textile object. As with the case of the tyre, it is possible to develop very simple structures for recovering energy.

The manufacturing method according to a first embodiment comprises a step for the manufacture of a conductive sheet covered with Teflon which forms a first assembly.

Then the sheet thus produced is incorporated into the body of the sweater in a zone located facing the sleeves.

During another step, another conductive sheet is incorporated into the sleeve of the sweater forming a second assembly, facing the sheet covered with Teflon incorporated into the body of the sweater.

Finally the two conductive sheets are connected to an electronic circuit which uses the electrical energy produced.

The method of production according to a second embodiment comprises a step for manufacturing copper wires surrounded by Teflon forming a first assembly, and for producing copper wires surrounded by nylon forming a second assembly.

In a following step, the incorporation of the copper wires surrounded by Teflon into the body of the sweater is carried out, in a zone located facing the sleeves.

In a following step, the copper wires surrounded by nylon are incorporated into the sleeve of the sweater, facing the Teflon surrounded wires.

Finally the copper wires of the two assemblies are connected to an electronic circuit which uses the electrical energy produced during the movement of the individual wearing the sweater.

1-35. (canceled)

36. A method for recovering energy by a device for recovering energy including a first assembly and a second assembly placed facing each other and that can move relative to each other, the first assembly including at least a first conductive element and a first dielectric element carried by the first conductive element, and the second assembly including at least a second conductive element, the first dielectric element being arranged between the first conductive element and the second conductive element, the first dielectric element configured to come into contact with a part of the second assembly, and wherein a material of the first dielectric element and a material of the part of the second assembly with which the first dielectric element makes contact exhibit different triboelectric affinities, the method comprising:
pre-charging the first dielectric element of the first assembly, a charge on the first dielectric element being fully or partly produced by a triboelectric effect at a time of the first dielectric element making contact with an element of the second assembly as a contact element;
relative movement of the first and second assemblies between a first position, as a contact position, for which the first pre-charged dielectric element is in contact with the contact element of the second assembly and exhibits a first contact surface area, and a second position as a separated position, for which the contact element of the second assembly is separated from the first dielectric contact, so that they are no longer in contact and such that a gap exists between the first dielectric element and the contact element, the movement inducing a variation in capacitance between the first dielectric element of the second conductive element;
flow, during the movement, of a current between the first conductive element of the first assembly and an electric circuit, the current being induced by the relative movement of the first and second assemblies and inducing electrical energy in the electrical circuit.

37. A recovery procedure according to claim 36, wherein the variation in capacitance between the first dielectric element and the second conductive element during the movement is equal to at least 20% of the capacitance value in the contact position.

38. A recovery procedure according to claim 37, wherein the variation in capacitance between the first dielectric element and the second conductive element at a time of the movement is equal to at least 40% of the capacitance value in the contact position.

39. A recovery method according to claim 36, wherein in the contact position a first equilibrium state occurs between the first conductor, the first dielectric element, and the second conductive element, and wherein in the separated position a second equilibrium state occurs between the first dielectric element and the first conductive element, a change from the first equilibrium state to the second equilibrium state causing an electric current to flow between the first conductive element of the first assembly and the electrical circuit.

40. A device for recovering energy comprising:
a first and a second assembly placed facing each other and that can move one relative to the other,
the first assembly comprising at least one first conductive element and a first dielectric element carried by the first conductive element, and the second assembly comprising at least one second conductive element, the first dielectric element being arranged between the first and second conductive element, the first dielectric element configured to make contact with a part of the second assembly, and wherein a material of the first dielectric element and a material of the part of the second assembly with which the first dielectric element makes contact exhibit different triboelectric affinities, the first dielectric element of the first assembly configured to exhibit a charge fully or partly obtained by a triboelectric effect at a time the first dielectric element makes contact with an element of the second assembly as a contact element,
the device allowing relative movement of the first and second assemblies between a first contact position, for which the first pre-charged dielectric element is in contact with the contact element of the second assembly and exhibits a first contact surface area, and a second separated position, for which the contact element of the second assembly is separated from the first dielectric element so that they are no longer in contact and such that a gap exists between the first dielectric element and the contact element, the movement inducing a variation in capacitance between the first dielectric element and the second conductive element,
the device further comprising an electrical circuit connected to the first conductive element such that an electric current is configured to flow, during the movement, between the first conductive element of the first assembly and the electrical circuit, the current being induced by the relative movement of the first and second assemblies and inducing electrical energy in the electrical circuit.

41. An energy recovery device according to claim 40, wherein the electrical circuit links the first conductive element and the second conductive element.

42. An energy recovery device according to claim 41, wherein the second conductive element forms a part of the second assembly with which the first dielectric element makes contact.

43. An energy recovery device according to claim 41, wherein the second assembly comprises a second dielectric element carried by the second conductive element, and arranged between the first dielectric element and the second conductive element, the second dielectric element forming the part with which the first dielectric element makes contact.

44. An energy recovery device according to claim 40, comprising a first and a second assembly facing each other, wherein the first assembly comprises at least one pair of adjacent conductive elements each of which is covered by a dielectric element, the two dielectric elements having different triboelectric affinities, and the second assembly comprising at least one second conductive element having a triboelectric affinity which is between the triboelectric affinities of the two dielectric elements of the first assembly, wherein the electrical circuit links the two or more conductive elements of the first assembly.

45. An energy recovery device according to claim 44, wherein the second assembly is formed by a conductive element covered by a dielectric element.

46. An energy recovery device according to claim 44, wherein each of the first and second assemblies comprise at least one pair of two adjacent conductive elements each covered by a dielectric element, wherein the two dielectric elements of each pair have different triboelectric affinities, wherein the facing dielectric elements have different triboelectric affinities, and wherein the electrical circuit is connected between the conductive elements of each pair.

47. An energy recovery device according to claim 44, wherein each of the first and second assemblies comprises at least one pair of two adjacent conductive elements each covered by a dielectric element, wherein the two dielectric elements of each pair have different triboelectric affinities, and wherein the facing dielectric elements have different triboelectric affinities, the conductive elements of the second assembly being short-circuited.

48. An energy recovery device according to claim 40, wherein the first and second assemblies are flat and are parallel, wherein at least one of the first and second assemblies are mounted on a frame to move at least perpendicularly to the other conductive assembly.

49. An energy recovery device according to claim 40, wherein the first and second assemblies are flat and are parallel, and wherein the first assembly is structured and the second assembly is structured so that at a time of movement of the first and/or of the second assembly along a direction parallel to the first and second assemblies, a variation in capacitance occurs between the one or more dielectric elements of the first assembly and the second assembly.

50. An energy recovery device according to claim 40, wherein the first and/or the second assembly comprises a plurality of wires each comprising a core and an envelope, the core forming a conductive element and the envelope forming a dielectric element.

51. An energy recovery device according to claim 50, wherein the wires are woven.

52. An energy recovery device according to claim 40, wherein at least the second assembly is flexible, so that it moves closer to the first assembly due to effect of an external force and so that it makes contact with the first element when the external force exhibits sufficient intensity.

53. An energy recovery device according to claim 40, wherein the first and the second assembly are held by a support, the support configured to deform elastically to move the first assembly closer to the second assembly due to effect of an external force and that it brings them into contact when the external force exhibits sufficient intensity.

54. An energy recovery device according to claim 40, wherein the first assembly has a curved shape in absence of an external force being applied, and is at a distance from the second assembly, the first assembly being deformed by application of an external force and making contact with the second assembly.

55. An energy recovery device according to claim 40, wherein the two assemblies are in permanent contact.

56. An energy recovery device according to claim 40, wherein the one or more dielectric elements are compressible.

57. An energy recovery device according to claim 40, wherein at least one of the assemblies has a rotation movement around an axis of rotation.

58. An energy recovery device according to claim 57, wherein the first and second assemblies are disk-shaped, wherein at least one of the assemblies can rotate around its axis, wherein axes of the first and second assemblies are secants, where both assemblies are permanently in contact by their edges, wherein the disk of the first assembly is divided into angular sectors, wherein some angular sectors are covered by some first dielectric element, and wherein some angular sectors are not covered by some first dielectric element.

59. An energy recovery device according to claim 57, wherein the first and second assemblies are parallel, with the first assembly being disk-shaped and being divided into angular sectors, wherein some first angular sectors are covered by the first dielectric element, and wherein some second angular sectors are or are not covered by the first dielectric element, wherein the first angular sectors are permanently in contact with the second assembly.

60. An energy recovery device according to claim 59, wherein the second assembly is disk-shaped, wherein axes of the disks coincide with an axis of rotation.

61. An energy recovery device according to claim 57, wherein the second assembly can rotate and has a form of an angular sector which can rotate around the axis of rotation.

62. An energy recovery device according to claim 41, wherein the first dielectric element is made of Teflon and the second conductive element is made of aluminium.

63. An energy recovery device according to claim 42, wherein the first dielectric element is made of Teflon and the second dielectric element is made of nylon or of wool.

64. A system comprising at least two energy recovery devices according to claim 40, connected in parallel or in series.

65. A system comprising at least one energy recovery device according to claim 40 and means of storage of the recovered energy before it is transferred to the user circuit.

66. A system according to claim 64, comprising at least one communication sensor configured to carry out a measurement, processing it and transmitting it by radio to a receiver once an amount of energy stored in the means of storage is greater than a given threshold.

67. A garment comprising at least one device according to claim 40, wherein the first assembly and the second assembly are carried by two parts of the garment facing each other and configured to move relative to one another and to make contact, or wherein the two parts are formed by two legs of trousers.

68. A garment according to claim 67, comprising means for processing a variation in current or of the electrical voltage recovered as a function of time to determine information about relative movement of the parts of the garment.

69. An automotive vehicle tire comprising at least one recovery device according to claim 36, wherein one of the assemblies of the device is fixed onto an interior face of a tire tread.

70. A tire according to claim 69, comprising means for processing a variation in current or electrical voltage recovered as a function of time, to determine information regarding the tire, or a speed of rotation, or pressure, or temperature, or acceleration.
